(19) United States
(12) Patent Application Publication
(10) Pub. No.: US 2008/0124642 A1
(43) Pub. Date: May 29, 2008

(54) TONER FOR DEVELOPMENT OF ELECTROSTATIC LATENT IMAGE

(75) Inventors: Yukinori Nakayama, OSAKA-SHI (JP); Kousuke Satou, OSAKA-SHI (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/945,429

(22) Filed: Nov. 27, 2007

(30) Foreign Application Priority Data
Nov. 29, 2006 (JP) 2006-321712
Nov. 29, 2006 (JP) 2006-321713
Nov. 29, 2006 (JP) 2006-321714
May 8, 2007 (JP) 2007-123713

(51) Int. Cl. G03G 9/08; G03G 15/08

(52) U.S. Cl. 430/108.6; 399/286

(57) ABSTRACT

An object of the present invention is to provide a toner for development of an electrostatic latent image, which has excellent developability and which is used in an electrophotographic image forming apparatus. One aspect of the present invention pertains to a toner for development of an electrostatic latent image, comprising cylindrical toner particles and titanium oxide particles added externally to the cylindrical toner particles, wherein the titanium oxide particles have an average primary particle size within a range from 10 to 100 nm, and the titanium oxide particles have a specific volume resistivity value within a specific range. Such a toner for development of an electrostatic latent image suppresses an image deletion phenomenon and is excellent in charge characteristics, and also exerts an extremely excellent effect on long-term printing durability.

### BACKGROUND OF THE INVENTION

1. Field of the Invention

The present invention relates to a toner for development of an electrostatic latent image, which is used in an electrophotographic image forming apparatus.

2. Description of the Related Art

In a developing device applied to electrophotographic image forming apparatuses such as a copying machine, a printer, a facsimile, and a composite machine thereof, a toner conveyed by a developing roller toward the surface of a photoconductor drum on which an electrostatic latent image based on image data is formed is supplied to form a toner image. In an image forming apparatus equipped with such a developing device, a toner image formed on a photoconductor drum is transferred onto a predetermined paper. Then, the transferred toner image is fixed on the paper by pressurizing and heating using a fixing device to form an image based on image data on the paper. After transferring the paper onto the toner image, the toner left on the surface of the photoconductor drum is removed by a cleaning blade. Then, electrification charge is removed by irradiating the surface of the photoconductor drum with discharged light using a discharging device for a subsequent image forming cycle.

As the toner used in the image forming apparatus, for example, there have hitherto been known a pulverized toner which is produced by milling a kneaded mixture of a toner material and a polymerized toner which is produced by polymerizing a predetermined monomer with a colorant and an additive in a medium such as water. To these toners, for example, external additives such as titanium oxide particles are externally added so as to improve long-term printing durability by suppressing the occurrence of filming on drum in which the toner adhered onto the surface of the photoconductor drum is left in the form of a film, thereby deteriorating developability.

It is known that, as the titanium oxide particles to be externally added, so-called ultrafine particles having a primary particle size of 10 to 100 nm are effective for charge stability. However, even if titanium oxide particles having a small particle size are externally added, the effect of abrading the toner adhered onto the photoconductor drum is scarcely exerted and the occurrence of filming on drum cannot be sufficiently suppressed.

Although titanium oxide particles having a comparatively large primary particle size (for example, titanium oxide particles having a primary particle size of 150 to 500 nm) can remove the toner adhered onto the photoconductor drum by abrasion, there is a problem that the charge amount of the toner decreases and an adverse influence is exerted on development characteristics.

There is known the following toner which is not influenced by environmental conditions such as humidity. For example, Japanese Unexamined Patent Publication (Kokai) No. 52-135739 (Patent Document 1) discloses a toner in which contamination of a photoconductor drum is prevented by using, as an external additive, metal oxide powders obtained by surface-treating with aminosilane. Also, Japanese Unexamined Patent Publication (Kokai) No. 10-3177 (Patent Document 2) discloses a toner in which environmental dependence of the toner is improved by mixing, as an external additive, a titanium compound obtained by reacting TiO(OH)₂ with a silane compound such as isobutyltrimethoxysilane.

However, these toners have a problem that defects such as filming on drum occur because of insufficient abrasive-performance to the surface of the photoconductor drum.

Furthermore, Japanese Unexamined Patent Publication (Kokai) No. 5-181306 (Patent Document 3) discloses a toner for development of an electrostatic latent image fixed abrasive fine particles having a hardness the same as or more than the hardness of the surface layer of the photoconductor drum onto the surface of the toner particles, in which the ratio of the particle size of toner particles to the particle size of abrasive fine particles is controlled. This toner can exert an excellent abrasive-performance to the surface of the photoconductor drum, but has a problem that charge characteristics are unstable in both environmental conditions of high temperature and high humidity conditions and low temperature and low humidity conditions.

### SUMMARY OF THE INVENTION

An object of the present invention is to provide a toner for development of an electrostatic latent image, which is used in an electrophotographic image forming apparatus and which has excellent developability.

One aspect of the present invention pertains to a toner for development of an electrostatic latent image, which is used in an image forming apparatus equipped with an amorphous silicon photoconductor, comprising cylindrical toner particles and titanium oxide particles added externally to the cylindrical toner particles, wherein the titanium oxide particles have an average primary particle size within a range from 10 to 100 nm, and the titanium oxide particles have a specific volume resistivity value within a range from 1×10¹ to 1×10⁷ Ω·cm.

Another aspect of the present invention pertains to a toner for development of an electrostatic latent image, which is used in an image forming apparatus equipped with an organic photoconductor (OPC), comprising cylindrical toner particles and titanium oxide particles added externally to the cylindrical toner particles, wherein the titanium oxide particles have an average primary particle size within a range from 10 to 100 nm, and the titanium oxide particles have a specific volume resistivity value within a range from 1×10⁴ to 1×10¹⁵ Ω·cm.

Objects, features, aspects and advantages of the present invention become more apparent from the following detailed description and accompanying drawings.

### BRIEF DESCRIPTION OF THE DRAWINGS

FIG. 1 is a schematic view showing a constitution of the toner for development of an electrostatic latent image according to a first embodiment of the present invention.

FIG. 2 is a schematic view for explaining a kneading step and a fiberizing step in the production of the cylindrical toner particles contained in the toner for development of an electrostatic latent image according to the first embodiment of the present invention.

FIG. 3 is a schematic view for explaining a cutting step in the production of the cylindrical toner particles contained in the toner for development of an electrostatic latent image according to the first embodiment of the present invention.

FIG. 4A is a schematic perspective view showing a shape of the cylindrical toner particle 13.

FIG. 4B is a schematic view above showing a shape of the cylindrical toner particle 13.

FIG. 4C is a schematic side view showing a shape of the cylindrical toner particle 13.

FIG. 5 is a schematic view showing a periphery of an image forming portion of an image forming apparatus 100.

FIG. 6 is a sectional view showing a two-component developing type developing device 34 installed in the image forming apparatus 100.

FIG. 7 is a sectional view showing a touchdown developing type developing device 35 installed in the image forming apparatus 100.

### DETAILED DESCRIPTION OF THE PREFERRED EMBODIMENTS

Embodiments of the present invention will now be described in detail. However, the present invention is not limited to the present embodiments.

### First Embodiment

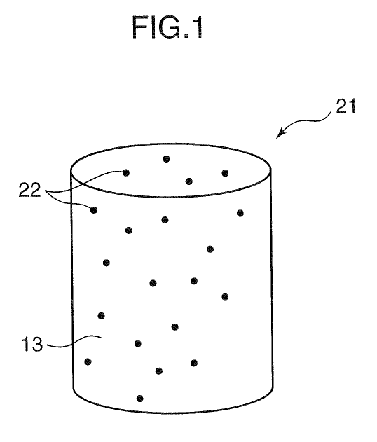

The toner for development of an electrostatic latent image according to a first embodiment of the present invention will now be described with reference to FIG. 1. FIG. 1 is a schematic view showing a constitution of the toner for development of an electrostatic latent image according to the first embodiment of the present invention. The toner for development of an electrostatic latent image 21 of the present embodiment is a toner used in an image forming apparatus equipped with an amorphous silicon (a-Si) photoconductor and is obtained by externally adding the titanium oxide particles 22 to the cylindrical toner particles 13 as shown in FIG. 1. The titanium oxide particles 22 have an average primary particle size within a range from 10 to 100 nm, and the titanium oxide particles 22 have a specific volume resistivity value within a range from 1×10¹ to 1×10⁷ Ω·cm.

The cylindrical toner particles are obtained by melt-kneading a toner material, forming a molten toner material into a fiber and cutting the fiber made of the toner material. The toner material contains 80 to 93% by mass of a binder resin, 3 to 8% by mass of a pigment (hereinafter also referred to as a colorant), 1 to 3% by mass of a charge control agent and 3 to 8% by mass of a releasant (hereinafter also referred to as a wax) which are as described in detail hereinafter.

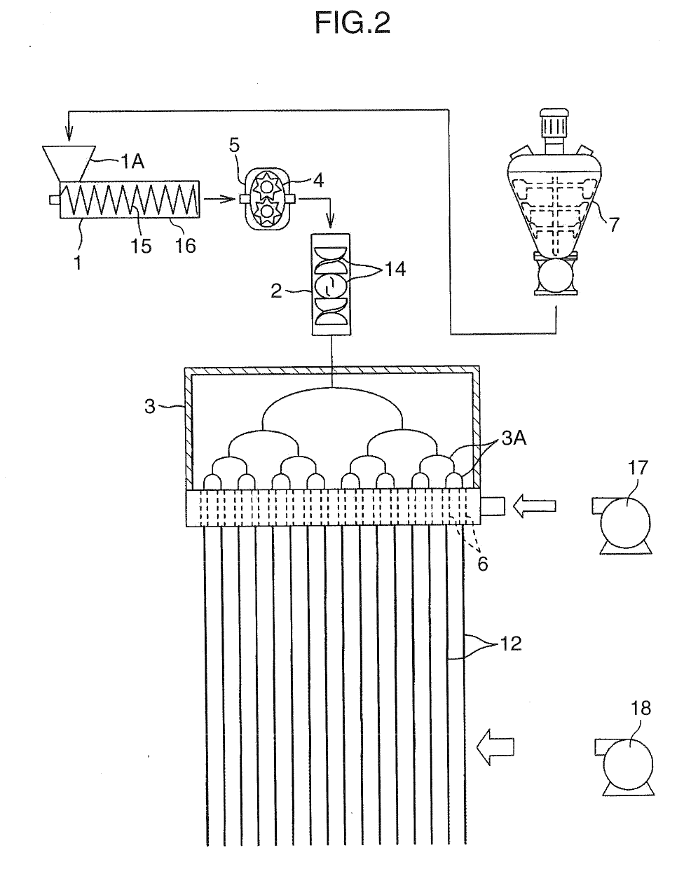

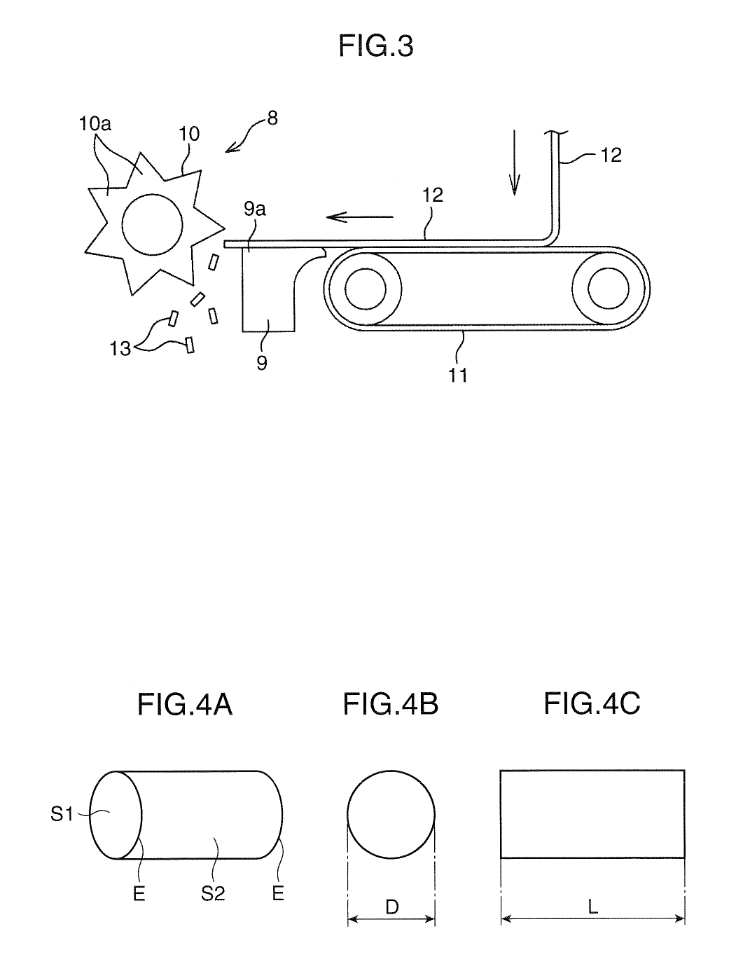

The method for producing the cylindrical toner particles includes the melt-kneading step of melt-kneading the toner material, the fiberizing step of forming the molten toner material obtained in the melt-kneading step into the fiber, and the cutting step of cutting the fiber made of the toner material to obtain the cylindrical toner particles. The method for producing the cylindrical toner particles will now be described in detail with reference to FIG. 2 and FIG. 3. FIG. 2 is a schematic view for explaining the kneading step and the fiberizing step in the production of the cylindrical toner particles contained in a toner for development of an electrostatic latent image according to the present embodiment. Also, FIG. 3 is a schematic view for explaining the cutting step in the production of the cylindrical toner particles contained in the toner for development of an electrostatic latent image according to the present embodiment.

### (Melt-Kneading Step and Fiberizing Step)

First, as shown in FIG. 2, the toner material is melt-kneaded in a single screw extruder 1. Specifically, the respective components of the toner material are supplied to a premixing device (for example, Cyclomix manufactured by Hosokawa Micron Corporation) 7 and, after premixing, the premix is supplied to the single screw extruder 1 through a hopper 1A. The single screw extruder 1 is equipped with a cylinder 16 with a heater (not shown), and is also equipped with a rotary screw 15 for kneading the toner material in the cylinder 16. The respective components supplied to the single screw extruder 1 are kneaded by the rotary screw 15. The single screw extruder 1 is equipped with a gear pump 4 which adjusts the discharge amount of the molten toner material at a discharge port and which is driven by a motor 5. The molten toner material is transferred to a static mixer 2 connected to the gear pump 4.

In the static mixer 2, multiple blades (three blades in FIG. 2) 14 composed of a twisted curved surface are disposed and a spiral flow passage is formed by the blades 14. The molten toner material transferred from the single screw extruder 1 is further kneaded by rotation of the blades 14 and the respective components constituting the toner material are dispersed uniformly and finely.

To the static mixer 2, a flow passage structure 3 including a multi-stage distributed flow passage 3A is connected. The molten toner material is supplied to the distributed flow passage 3A from the static mixer 2, heated by a heater (not shown) disposed in the flow passage structure 3, and then extruded into a fiber through nozzles 6 provided at flow passage outlets of the respective distributed flow passages 3A. The single screw extruder 1, the static mixer 2, the flow passage structure 3 and the gear pump 4 are respectively heated to a high temperature which is the melting point of the binder resin or higher, for example, about 130 to 240° C. by the heater (not shown) so as to adjust the viscosity of the molten toner material to a low viscosity.

The fiber-like molten toner materials extruded through the nozzles 6 are drawn by hot air blown from a hot air blowing device 17 and then quickly cooled by cold air blown from a cold air blowing device 18 to form fiber-like toner 12.

### (Cutting Step)

The cutting step of cutting the fiber-like toners 12 will now be described. As shown in FIG. 3, the fiber-like toners 12 are conveyed to a fiber cutting device 8 using a conveying device. Specifically, the fiber-like toners 12 are placed on a belt conveyor 11 as a conveying device and conveyed toward the fiber cutting device 8 in a horizontal direction. The fiber-like toner 12 is cooled to room temperature during conveying to form generally linear toner having a proper viscosity, which are then conveyed while arranging orderly in a horizontal direction. It is possible to use, as the conveying device, conveying means utilizing an air flow having a fixed flow rate and a fixed flow direction, in addition to the belt conveyor 11.

The fiber cutting device 8 is equipped with a stationary knife 9 extending in a direction intersecting perpendicularly to the conveying direction of the fiber-like toner 12 to be conveyed on the conveying device 11, and a rotary knife 10 which is rotation-driven by a motor (not shown). The fiber-like toner 12 is continuously supplied between the stationary knife 9 and the rotary knife 10. Then, the fiber-like toner 12 is sequentially cut by a shearing action produced between an edge 9a of the stationary knife 9 and a cutter blade 10a of the rotary knife 10 to continuously produce the cylindrical toner particles 13.

The length L of the cylindrical toner particles 13 can be adjusted by the ratio of the conveying speed of the fiber-like toner 12 to the rotary speed of the rotary knife 10. Also, the diameter D of the cylindrical toner particles 13 can be adjusted by the inner diameter of the discharge ports of the nozzles 6. the above-mentioned method for producing cylindrical toner particles comprising the melt-kneading step and the fiberizing step is referred to as a spinning method.

### (Shape of Cylindrical Toner Particles)

The shape of the cylindrical toner particle 13 will now be described with reference to FIG. 4. FIG. 4 is a schematic view showing a shape of the cylindrical toner particle 13. FIG. 4A is an enlarged perspective view, FIG. 4B shows a shape of an end surface (cut surface) and FIG. 4C shows a shape of a side surface. Thus, cylindrical toner particle having a cylindrical length (L) and a cylindrical diameter (D) as shown in FIG. 4 are obtained by the spinning method. While a cylindrical body free from distortion was described as the shape of the cylindrical toner particle in the present embodiment, some distortion is generated in the shape of the end surface and the shape of circumferential surface and cylindrical toner particles of the present invention also include such a cylindrical body with distortion.

D of the cylindrical toner particle 13 is preferably within a range from 4 to 9 μm. Also, L of the cylindrical toner particle 13 is preferably within a range from 4 to 13 μm. Furthermore, L is not less than D and L/D of the cylindrical toner particle 13 is more preferably from 1 to 2. The shape of the cylindrical toner particle 13 includes, for example, a cylindrical body measuring D=5 μm and L=7 μm.

L/D was determined by the following procedure. Namely, an image at 2,000 times magnification of the cylindrical toner particles was taken under a scanning electron microscope (SEM). At this time, 100 cylindrical toner particles were extracted at random from the image and then the cylindrical length and the cylindrical diameter of the respective cylindrical toner particles were measured. Then, the averages of the cylindrical length L and of the cylindrical diameter D were determined. In the case where the cut surface does not intersect perpendicularly to the central axis of the cylindrical toner (in the case where the cut surface is inclined or curved), the axis length of the central axis is referred to as the cylindrical length L.

As shown in FIG. 4A, the cylindrical toner particle has a cylindrical body and an edge E is formed at a boundary between an end surface (cut surface) S1 and a cylindrical circumferential surface S2. The toner particle exerts a proper scratching action to the surface of the photoconductor by the edge E.

The surface of the cylindrical toner particles thus formed may be treated with an additive which has conventionally been added to the toner, for example, colloidal silica or hydrophobic silica as long as the effect of the present invention is not adversely affected.

### (Toner Material)

Constituent components of the toner material will now be described in detail.

### (Binder Resin)

It is possible to use, as the binder resin constituting the toner material, those which have conventionally been used as a binder resin for a toner particles without any restriction. For example, thermoplastic resins such as a polystyrene-based resin, an acrylic-based resin, a styrene-acrylic-based copolymer, a polyethylene-based resin, a polypropylene-based resin, a vinyl chloride-based resin, a polyester-based resin, a polyamide-based resin, a polyurethane-based resin, a polyvinyl alcohol-based resin, a vinylether-based resin, a N-vinyl-based resin and a styrene-butadiene-based resin are preferably used.

The polystyrene-based resin includes, in addition to a styrene homopolymer, a copolymer of styrene and a monomer which is copolymerizable with styrene. Examples of the monomer which is copolymerizable with styrene include p-chlorostyrene; vinyl naphthalene; ethylene unsaturated monoolefins such as ethylene, propylene, butylene and isobutylene; vinyl halides such as vinyl chloride, vinyl bromide and vinyl fluoride; vinyl esters such as vinyl acetate, vinyl propionate, vinyl benzoate and vinyl butyrate; (meth)acrylate esters such as methyl acrylate, ethyl acrylate, n-butyl acrylate, isobutyl acrylate, dodecyl acrylate, n-octyl acrylate, 2-chloroethyl acrylate, phenyl acrylate, α-chloromethyl acrylate, methyl methacrylate, ethyl methacrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinyl pyrrole, N-vinylcarbazole, N-vinylindole and N-vinyl pyrrolidene. These monomers may be used alone, or two or more kinds of them may be used in combination.

With respect to the molecular weight of the polystyrene-based resin used as the binder resin, it is preferred that the molecular weight distribution has at least two peaks, a peak of comparatively low molecular weight within a range from 3,000 to 20,000 and a peak of comparatively high molecular weight within a range from 300,000 to 1,500,000 and Mw/Mn (mass average molecular weight/number average molecular weight) is 10 or more. If the molecular weight distribution of the polystyrene-based resin is within the above range, the toner particles having excellent fixability and anti-offset properties are obtained. The molecular weight distribution can be determined by GPC (gel permeation chromatography). For example, the molecular weight can be determined from a calibration curve which is preliminarily obtained using a standard polystyrene resin after measuring the time of elution from the column of a molecular weight measuring device HLC-8220 manufactured by Tosoh Corporation using THF (tetrahydrofuran) as the solvent.

As the polyester-based resin, for example, those obtained by polycondensation or copolycondensation of an alcohol component and a carboxylic acid component are used.

Specific examples of the alcohol component, dihydric alcohols include diols such as ethylene glycol, diethylene glycol, triethylene glycol, 1,2-propyleneglycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol; bisphenols such as bisphenol A, hydrogenated bisphenol A, polyoxyethylenated bisphenol A and polyoxypropylenated bisphenol A; and tri- or higher polyhydric alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5,-trihydroxymethylbenzene.

As the carboxylic acid component, for example, a di-, tri- or higher polyhydric carboxylic acid, and an acid anhydride and a lower alkyl ester thereof are used. Specific examples of the dihydric carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid or an alkyl- or alkenylsuccinic acid such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid or isododecenylsuccinic acid. Specific examples of the tri- or higher polyhydric carboxylic acid include 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and enpol trimer acid.

The softening point of the polyester-based resin is preferably from 110 to 150° C., and more preferably from 120 to 140° C., in view of excellent fixability.

The binder resin is preferably the above thermoplastic resin in view of good fixability. However, it is not required to use only the thermoplastic resin and a small amount of a crosslinked resin or thermosetting resin, whose gel fraction (the amount of a crosslinked moiety) is 10% by mass or less, may be used. The gel fraction is more preferably within a range from 0.1 to 10% by mass. When a small amount of the crosslinked resin or the thermoplastic having partially a crosslinked structure is used, storage stability and shape retention or durability of the toner can be improved without deteriorating fixability. The gel fraction can be measured using a Soxhlet extractor.

Specific examples of the thermosetting resin include epoxy-based resins such as a bisphenol A type epoxy resin, a hydrogenated bisphenol A type epoxy resin, a novolak type epoxy resin, a polyalkylene ether type epoxy resin and a cyclic aliphatic epoxy resin, and a cyanate-based resin. These thermosetting resins may be used alone, or two or more kinds of them may be used in combination.

The binder resin is preferably a resin having at least one functional group selected from a hydroxyl group, a carboxyl group, an amino group and a glycidoxy (epoxy) group in the molecule so as to improve dispersibility of a magnetic powder. It can be confirmed using a FT-IR device whether or not the binder resin has these functional groups and also the amount of these functional groups can be determined using a titration method.

The glass transition point (Tg) of the binder resin is preferably within a range from about 55 to 70° C. When the glass transition point of the binder resin is lower than 55° C., the resulting toners may fuse to each other, thereby deteriorating storage stability. In contrast, when the glass transition point of the binder resin is higher than 70° C., fixability of the toner may become inferior. The glass transition point of the binder resin can be determined from the change point of the specific heat using a differential scanning calorimeter (DSC). For example, the glass transition point can be determined by the following procedure. Namely, 10 mg of a measuring sample is placed in an aluminum pan and measurement is performed at a measuring temperature within a range from 25 to 200° C. and a temperature raising rate of 10° C./min using a differential scanning calorimeter DSC-6200 manufactured by Seiko Instruments Inc. as the measuring device and using a vacant aluminum pan as the reference. The glass transition point can be determined from the change point of the resulting endothermic curve.

### (Colorant)

Specific examples of the colorant constituting the toner material include black pigments, for example, carbon blacks such as acetylene black, lamp black and aniline black; yellow pigments such as Chrome Yellow, Zinc Yellow, Cadmium Yellow, Yellow Iron Oxide, Mineral Fast Yellow, Nickel Titanium Yellow, Nables Yellow, Naphthols Yellow S, Hansa Yellow G, Hansa Yellow 10G, Benzidine Yellow G, Benzidine Yellow GR, Quinoline Yellow Lake, Permanent Yellow NCG and Tartrazine Lake; orange pigments such as Chrome Orange, Molybdenum Orange, Permanent Orange GTR, Pyrazolone Orange, Vulcan Orange, Indathrene Brilliant Orange RK, Benzidine Orange G and Indathrene Brilliant Orange GK; red pigments such as Blood Red, Cadmium Red, Red Lead, Cadmium Mercury Sulfide, Permanent Red 4R, Lithol Red, Pyrazolone Red, Watching Red Calcium Salt, Lake Red D, Brilliant Carmine 6B, Eosine Lake, Rhodamine Lake B, Alizarin Lake and Brilliant Carmine 3B; violet pigments such as Manganese Violet, Fast Violet B and Methyl Violet Lake; blue pigments such as Prussian Blue, Cobalt Blue, Alkali Blue Lake, Victoria Blue Lake, Phthalocyanine Blue, Metal-Free Phthalocyanine Blue, Partially Chlorinated Phthalocyanine Blue, Fast Skyblue and Indathrene Blue BC; green pigments such as Chromium Green, Chromium Oxide, Pigment Green B, Malachite Green Lake and Fanal Yellow Green G; white pigments such as zinc white, titanium oxide, antimony white, zinc sulfide, barite powder, barium carbonate, clay, silica, white carbon, talc and alumina white.

The amount of the colorant to be added is preferably from 2 to 20 parts by mass, and more preferably from 5 to 15 parts by mass, based on 100 parts by mass of the binder resin.

### (Charge Control Agent)

It is possible to use, as the charge control agent constituting the toner material, those which have conventionally been used as a charge control agent for a toner particle without any restriction. Specific examples thereof include charge control agents which exhibit positive chargeability, for example, nigrosin, a quaternary ammonium salt compound and a resin type charge control agent obtained by bonding a resin with an amine-based compound.

The amount of the charge control agent to be added is preferably from 0.5 to 10 parts by mass, and more preferably from 1 part by mass to 5 parts by mass, based on 100 parts by mass of the binder resin.

### (Wax)

It is possible to use, as the releasant (wax) constituting the toner material, those which have conventionally been used as a releasant for a toner particle without any restriction. Specific examples thereof include vegetable waxes such as carnauba wax, sugarcane wax and Japan wax; animal waxes such as beeswax, insect wax, whale wax and wool wax; and synthetic hydrocarbon-based waxes such as Fischer-Tropsch (hereinafter referred sometimes as to “FT”) wax having an ester on the side chain, polyethylene wax and polypropylene wax. Of these releasants, a FT wax having an ester on the side chain and a polyethylene wax are preferably used in view of excellent dispersibility.

The endothermic main peak in the endothermic curve measured by DSC of the releasant (wax) is preferably within a range from 70 to 120° C. When the endothermic main peak is lower than 70° C., a blocking phenomenon and a hot-offset phenomenon of the toner may occur. In contrast, when the endothermic main peak is higher than 120° C., fixability at low temperature may not be obtained.

The amount of the wax to be added is preferably within a range from 0.1 to 20 parts by mass based on 100 parts by mass of the binder resin. When the amount is less than 0.1 parts by mass, the addition effect is less likely to be obtained. In contrast, when the amount is more than 20 parts by mass, blocking resistance deteriorates and also the releasant may fall from the toner.

### (External Additive)

In the toner for development of an electrostatic latent image according to the present embodiment, titanium oxide particles as an external additive are added to the cylindrical toner particles. Titanium oxide particles are preferred because they have a function capable of adjusting charging properties of the toner as compared with other external additives such as silica and are excellent in abrasive-performance to the surface of the photoconductor.

The titanium oxide particles used in present embodiment are so-called titanium oxide ultrafine particles having an average primary particle size of 10 to 100 nm. When the average primary particle size is less than 10 nm, particles are embedded in the toner from the toner surface during long-term use because they have too small particle size, and thus it is impossible to exert the effect of charge stability of the titanium oxide particles. In contrast, when the average primary particle size is more than 100 nm, the charge amount of the toner decreases to cause image defects such as decrease in image density. Also, the average primary particle size of the titanium oxide particles is preferably 50 nm or more in view of an increase in image density. The average primary particle size can be expressed by an arithmetic mean value calculated from about 100 measured values of the diameter selected optionally from an image at 200,000 times magnification taken under a transmission electron microscope (TEM) of titanium oxide particles.

The specific volume resistivity value of the titanium oxide particles is within a range from 1×10¹ to 1×10⁷ Ω·cm, and preferably from 1×10² to 1×10⁶ Ω·cm. When the specific volume resistivity value is too low, it becomes impossible to impart sufficient charging properties to the toner and the image density may decrease. In contrast, when the specific volume resistivity value is too high, the charge amount excessively increases and charge-up arises, and thus image density may decrease and durability may deteriorate.

The preferable specific volume resistivity value of the titanium oxide particles varies depending on the image forming apparatus using the toner for development of an electrostatic latent image. When used in an image forming apparatus equipped with an amorphous silicon photoconductor, like the toner for development of an electrostatic latent image according to the present embodiment, the specific volume resistivity value of titanium oxide particles is preferably lower than that when used in an image forming apparatus equipped with an organic photoconductor (OPC). The reason is considered as follows. Namely, since the amorphous silicon photoconductor has lower withstanding voltage as compared with the organic photoconductor (OPC), microdefects are likely to be formed on the photoconductor film by leaking micro discharge due to accumulate a high-resistance toner at the cleaning portion. Therefore, in the case of the toner for development of an electrostatic latent image according to the present embodiment, using titanium oxide particles having a low specific volume resistivity, the occurrence of microdefects of the photoconductor film is prevented by properly discharging charges stored in the toner to a member of the image forming apparatus. The specific volume resistivity value of the titanium oxide particles can be determined by the following procedure. Namely, titanium oxide is placed in a cylindrical cell for measuring having a diameter of 25 mm and a load of 1 kg is applied under the conditions of a temperature of 23° C. and a relative humidity of 50%, and then the specific volume resistivity value is determined at an applied voltage of DC 10 V using an ULTRA HIGH RESISTANCE METER R8340A manufactured by ADVANTEST Corporation.

On the surface of the titanium oxide particles, preferably, a tin oxide film containing antimony in the form of a solid solution is formed by adding tin oxide and antimony to the surface, and the specific volume resistivity value of the titanium oxide particles adjusted by the additive amount. The additive amount also varies depending on the particle size of the titanium oxide particles, but is preferably from 45 to 75 parts by mass based on 100 parts by mass of the titanium oxide particles. It is preferred to hydrophobize the titanium oxide particles by further adding 5 to 10 parts by mass of a coupling agent, for example, a titanate coupling agent, based on 100 parts by mass of the titanium oxide particles.

### (Magnetic Carrier)

The toner for development of an electrostatic latent image according to the present embodiment is used in combination with a carrier such as a magnetic carrier.

It is possible to use, as the carrier, a carrier which has conventionally been used as the carrier of the developer without any restriction. The carrier is preferably a carrier obtained by coating a carrier core material with a resin in view of control of the charge amount and polarity of the toner, improvement in temperature dependence, prevention of filming (spent phenomenon) on the carrier, and an improvement in fluidity.

Specific examples of the carrier core material include particles made of iron, oxidized iron, reduced iron, magnetite, copper, silicon steel, ferrite, nickel and cobalt; particles made of alloys of the above-mentioned metals and manganese, zinc and aluminum, and particles made of an iron-nickel alloy and an iron-cobalt alloy; ceramics particles made of titanium oxide, aluminum oxide, copper oxide, magnesium oxide, lead oxide, zirconium oxide, silicon carbide, magnesium titanate, barium titanate, lithium titanate, lead titanate, lead zirconate and lithium niobate; particles of substances having a high dielectric constant such as ammonium dihydrogen phosphate, potassium dihydrogen phosphate and rochelle salt; and resin carriers obtained by dispersing the above-mentioned magnetic particles in a resin.

Specific examples of the resin used for coating the carrier core material include a (meth) acrylic-based polymer, a styrene-based polymer, a styrene-(meth)acrylic-based copolymer, an olefinic-based polymer (polyethylene, chlorinated polyethylene, polypropylene, etc.), polyvinyl chloride, polyvinyl acetate, polycarbonate, a cellulose resin, a polyester resin, an unsaturated polyester resin, a polyamide resin, a polyurethane resin, an epoxy resin, a silicone resin, a fluoro resin (polytetrafluoroethylene, polychlorotrifluoroethylene, polyvinylidene fluoride, etc.), a phenol resin, a xylene resin, a diallyl phthalate resin, a polyacetal resin and an amino resin. These resins may be used alone or in combination.

The weight average particle size of the carrier is preferably within a range from 10 to 200 μm, and more preferably from 30 to 150 μm.

If necessary, the resin coat layer may contain additives for adjusting characteristics of the resin coat layer, such as silica, alumina, carbon black, an aliphatic acid metal salt, a silane coupling agent and a titanate coupling agent.

There are no restrictions on the thickness of the resin coat layer as long as the resin coat layer has almost the same thickness as that of the prior art. The thickness of the resin coat layer is preferably from 0.01 to 10% by mass, and more preferably from 0.05 to 5% by mass, in terms of the weight of coating onto the carrier core material.

To the toner for development of an electrostatic latent image according to the present embodiment, conventionally known external additives such as silica, alumina, tin oxide, titanium oxide, strontium oxide and various resin powders so as to improve fluidity of the developer can be added as long as the effect of the present invention is not adversely affected.

The toner for development of an electrostatic latent image according to the present embodiment can be used in an image forming apparatus described hereinafter after mixing with the carrier in a proper ratio. There are no restrictions on the ratio of the toner to the carrier as long as the composition is the same as that of a conventional developer.

### (Image Forming Apparatus)

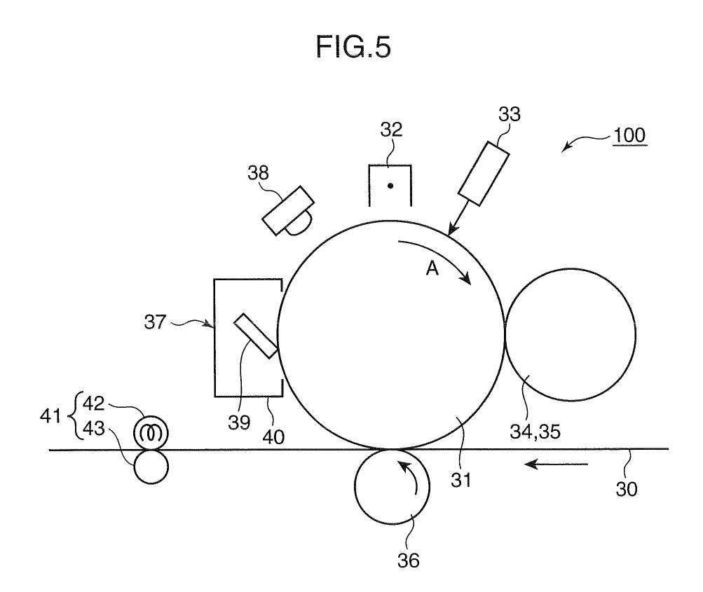

The image forming apparatus using the toner for development of an electrostatic latent image according to the present embodiment will now be described. FIG. 5 is a schematic view showing a periphery of an image forming portion of the image forming apparatus 100. The image forming apparatus 100 is an apparatus which forms a predetermined image on a paper 30 as a recording medium by an electrophotographic method. As shown in FIG. 5, the image forming apparatus 100 is equipped with a charging device 32, an exposure device 33, developing device 34,35, a transfer roller 36, a cleaner 37, and a discharging device 38 around a photoconductor drum 31 having photosensitivity along a rotation direction A of the photoconductor drum 31. The cleaner 37 and the discharging device 38 may be disposed to be opposite each other.

In the photoconductor drum 31, an amorphous silicon photoconductor is used. In the present embodiment, an image carrier will be described by way of a photoconductor drum as a drum-shaped photoconductor, but is not limited thereto and it is possible to be applied to a belt-shaped photoconductor and a sheet-like photoconductor.

The charging device 32 gives a predetermined potential on the surface of the photoconductor drum 31 by producing a corona discharge. The exposure device 33 enables a surface potential of an electrostatic latent image to selectively damp by irradiation with light based on image data. The developing device 34, 35 enable the electrostatic latent image formed on the surface of the photoconductor drum 31 to develop with the toner to form a toner image, and examples thereof include a two-component developing type developing device 34 and a touchdown type developing device 35 described hereinafter. The transfer roller 36 enables the toner image formed on the photoconductor drum 31 to transfer onto the paper 30. The cleaner 37 is composed of a rubber blade 39 for removing toner left on the surface of the photoconductor drum 31, and a recovery vessel 40, for recovering the toner removed by the rubber blade 39. The discharging device 38 enables surface charge of the photoconductor drum 31 to be discharged using lamp light.

Furthermore, the image forming apparatus 100 is equipped with a fixing device 41 (a heating roller 42 and a pressure roller 43) in a downstream side in a conveying direction of the paper 30. The fixing device 41 enables the toner image to be fixed to the paper 30 onto which the image is transferred by applying heat and pressure, and thus a predetermined image is formed on the paper 30.

The developing device 34, 35 used in the image forming apparatus 100 will now be described.

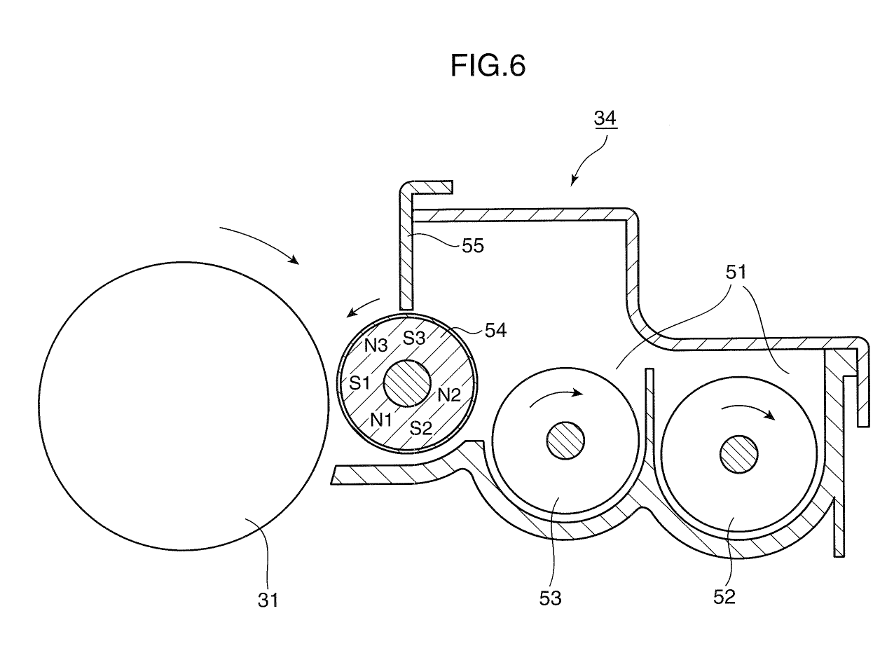

First, the two-component developing type developing device 34 will be described. FIG. 6 is a sectional view showing the two-component developing type developing device 34 installed in the image forming apparatus 100. The developing device 34 is equipped with a developer encasing portion 51 in which a two-component developer containing the toner and the carrier (not shown) is encased, two stirring rollers 52, 53 for stirring the two-component developer, and a developing roller 54 for migrating the toner onto the surface of the photoconductor drum 31. Also, a blade 55 and the developing roller 54 are provided to face each other.

The stirring rollers 52, 53, each having a spiral fin, enable the two-component developer to stir in an opposite direction and to charge the toner of the two-component developer. Furthermore, the stirring roller 53 supplies the two-component developer containing the charged toner and the carrier to the developing roller 54. The developing roller 54 enables a magnet disposed therein to adsorb the two-component developer and to convey the two-component developer. At this time, the two-component developer is formed into a magnetic brush by the magnet in the developing roller 54. When the magnetic brush passes between the blade 55 and the developing roller 54, the thickness of the magnetic brush is regulated. The toner of the magnetic brush conveyed to the vicinity of the photoconductor drum 31 is migrated to the magnetic brush by the potential difference generated between the photoconductor drum 31 and the developing roller 54.

By the image forming cycle described above, the developing device 34 enables development based on the electrostatic latent image formed on the photoconductor drum 31.

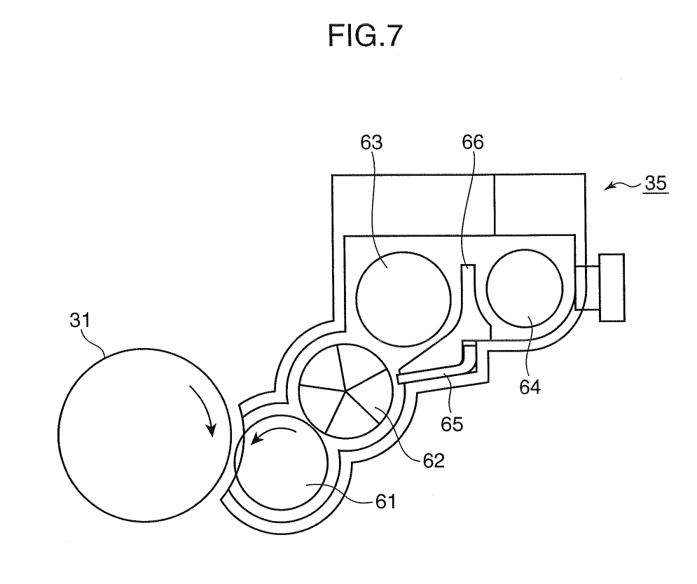

The touchdown developing type developing device 35 will now be described. FIG. 7 is a sectional view showing the touchdown developing type developing device 35 installed in the image forming apparatus 100.

The developing device 35 is equipped with a developing roller 61, a magnetic roller 62, stirring rollers 63, 64, a blade 65, and a partition plate 66.

The stirring rollers 63, 64, each having a spiral fin, enable the two-component developer to stir in an opposite direction and to charge the toner of the two-component developer. Furthermore, the stirring roller 63 supplies the two-component developer containing the charged toner and the carrier to the magnetic roller 62.

The magnet roller 62 enables a magnet disposed therein to adsorb the two-component developer and to convey the two-component developer. At this time, the two-component developer is formed into a magnetic brush by the magnet in the magnetic roller 62. When the magnetic brush passes between the blade 65 and the magnetic roller 62, the thickness of the magnetic brush is regulated. The toner of the magnetic brush conveyed to the vicinity of the developing roller 61 is migrated to the magnetic brush by the potential difference generated between the developing roller 61 and the magnetic roller 62.

The developing roller 61 enables the toner migrated from the magnetic roller 62 to convey while supporting it on the surface. Then, the toner conveyed to the vicinity of the photoconductor drum 31 is migrated to the photoconductor drum 31 by the potential difference generated between the photoconductor drum 31 and the developing roller 61.

By the image forming cycle described above, the developing device 35 enables development based on the electrostatic latent image formed on the photoconductor drum 31.

In the two-component developing type developing device 34 and the touchdown developing type developing device 35, the carrier is not consumed by development and is recovered as is in the device, and then used after mixing again with the toner.

The above-mentioned image forming apparatus is an apparatus in which a toner image is directly transferred to a paper, but is not limited to such an image forming apparatus. For example, it may be a so-called tandem type image forming apparatus in which toner images of multiple colors are once transferred onto an intermediate transfer belt and the toner image of multiple colors transferred onto the intermediate transfer belt is transferred onto a paper. The tandem type image forming apparatus has excellent high speed properties, but has a problem that multiple image forming units equipped with a photoconductor drum and a developing device must be disposed, and thus the image forming apparatus is upsized. To cope with this problem, there is proposed a downsized tandem type image forming apparatus in which downsized image forming units are disposed so as to decrease the distance between photoconductor drums. In the downsized tandem image forming apparatus, a vertical type developing device is advantageously used so as to minimize the size of the image forming unit in the width direction. Namely, it is preferred to dispose a developing device in the upward direction of the photoconductor drum.

Such a developing device of a downsized tandem image forming apparatus is preferably a non-contact developing type developing device in which there is a gap between the photoconductor drum and the developing roller and therefore a magnetic brush does not contact with the photoconductor drum because the carrier does not adhere onto the photoconductor and the photoconductor is not scratched by the magnetic brush. Therefore, as the developing device to be applied to the downsized tandem image forming apparatus, a touchdown developing type developing device 35 as shown in FIG. 7 is more preferred as compared with the two-component developing type developing device 34 as shown in FIG. 6 in which a toner is supplied from a magnetic brush in the form of a developing roller.

### EXAMPLES

The toner for development of an electrostatic latent image according to the first embodiment will now be described in more detail by way of Examples. However, the present invention is not limited to the following Examples.

### Example A

First, examples of a toner for development of an electrostatic latent image used in the two-component developing type image forming apparatus as shown in FIG. 6 equipped with an amorphous silicon photoconductor will now be described.

### (Synthesis of Binder Resin)

In a reaction vessel equipped with a thermometer, a stirrer, a nitrogen introducing tube and a refluxing tube, 300 parts by mass of xylene was charged and a solution prepared by dissolving a monomer mixture of 845 parts by mass of styrene and 155 parts by mass of n-butyl acrylate and 8.5 parts by mass of a polymerization initiator (di-tert-butyl peroxide) in 125 parts by mass of xylene was added dropwise at a liquid temperature maintained at 170° C. over 3 hours while continuously introducing nitrogen through a nitrogen introducing tube. After the completion of dropwise addition, the polymerization reaction was performed by stirring for one hour while maintaining a liquid temperature at 170° C. Then, xylene was removed from the resulting resin solution by distillation under reduced pressure to obtain a binder resin composed of a styrene-n-butyl acrylate copolymer (styrene/acrylic resin).

### (Production of Cylindrical Toner Particles)

Using 92 parts by mass of the resulting a styrene/acrylic resin, 3 parts by mass of a polyethylene wax (110P manufactured by Mitsui Mining Co., Ltd.), 1 part by mass of a charge control agent (P-51 manufactured by Orient Chemical Industries, Ltd.) and 4 parts by mass of a colorant (carbon black: MA-100 manufactured by Mitsubishi Chemical Corporation) as toner materials, cylindrical toner particles were produced by the above method using the apparatuses shown in FIG. 2 and FIG. 3. The resulting cylindrical toner particles had a diameter D of about 5 μm and a cylindrical length L of about 7 μm.

### (Production of Toner for Development of Electrostatic Latent Image)

To the resulting cylindrical toner particles, 1.0% by mass of titanium oxide particles shown in Table 1 as an external additive and 1.5% by mass of silica (RA-200H manufactured by Nippon Aerosil Co., Ltd.) were added, followed by mixing using a Henschel mixer (manufactured by Mitsui Mining Co., Ltd.) to prepare a toner for development of an electrostatic latent image as shown in Table 2.

TABLE 1

| | Primary | Specific volume |
|---|---|---|
| | particle size | resistivity value |
| | (nm) | (Ω · cm) |
| Example 1 | 20 | 5 × 10³ |
| Example 2 | 50 | 9 × 10³ |
| Example 3 | 90 | 3 × 10³ |
| Example 4 | 50 | 3 × 10² |
| Example 5 | 50 | 7 × 10⁶ |
| Comparative Example 1 | 7 | 4 × 10³ |
| Comparative Example 2 | 150 | 5 × 10³ |
| Comparative Example 3 | 50 | 2 × 10⁰ |
| Comparative Example 4 | 50 | 7 × 10⁹ |

Using a two-component developer obtained by mixing 10 parts by mass of the resulting toner for development of an electrostatic latent image with 100 parts by mass of a ferrite carrier (Cu—Zn ferrite carrier having an average particle size of 50 μm) in a two-component developing type image forming apparatus equipped with an amorphous silicon photoconductor (image forming apparatus obtained by modifying a page printer “FS-1920” manufactured by KYOCERA MITA Corporation so as to employ a two-component developing method), the image was evaluated (Evaluation of image density, Evaluation of fog, Evaluation of image deletion).

### (1) Evaluation of Image Density and Evaluation of Fog

Using the above image forming apparatus, a pattern image for evaluation of an image was printed under a normal temperature and pressure environment at a temperature of 20° C. and a humidity of 65% RH and the resulting image was referred to as an initial image. After printing 100,000 sheets, the pattern image for evaluation of an image was printed and the resulting image was referred to as a durable image (image after printing 100,000 sheets). The image density of the solid portion of the initial image and that of the durable image were measured using a Macbeth reflection densitometer (RD914 manufactured by Gretag Macbeth Co.). A sample having an image density of 1.30 or more was rated as “Pass”, whereas, a sample having an image density of less than 1.30 was rated as “Fail”. The results are shown in Table 2.

It was also visually observed whether or not fog occurs in a blank portion of the initial image and the durable image. With respect to fog, a sample rated as A passed, whereas, a sample rated as B or C failed. The evaluation results are shown in Table 2.

A: Fog is scarcely recognized.

B: Fog is slightly recognized.

C: Fog is considerably recognized.

### (2) Evaluation of Image Deletion

Under a normal temperature and pressure at a temperature of 20° C. and a humidity of 65% RH, 5,000 sheets were continuously printed. After standing under a high temperature and high humidity at a temperature of 35° C. and a humidity of 85% RH for 24 hours, a pattern for evaluation of an image was printed and image deletion was evaluated by visually observing the level of image deletion. A sample rated as A passed, whereas, a sample rated as B or C failed. The evaluation results are shown in Table 2.

A: Image deletion is scarcely recognized, and image is clear and good.

B: Image deletion is slightly recognized.

C: Image deletion is considerably recognized.

TABLE 2

| Image characteristics | |
|---|---|
| Image density | Fog |

| | | After | | After | Image |
|---|---|---|---|---|---|
| | Initial | printing | Initial | printing | deletion |
| Example 1 | 1.37 | 1.36 | A | A | A |
| Example 2 | 1.41 | 1.39 | A | A | A |
| Example 3 | 1.39 | 1.38 | A | A | A |
| Example 4 | 1.39 | 1.37 | A | A | A |
| Example 5 | 1.40 | 1.38 | A | A | A |
| Comparative | 1.36 | 1.25 | A | C | C |
| Example 1 | | | | | |
| Comparative | 1.29 | 1.14 | B | C | A |
| Example 2 | | | | | |
| Comparative | 1.27 | 1.07 | B | C | A |
| Example 3 | | | | | |
| Comparative | 1.38 | 1.11 | A | C | A |
| Example 4 | | | | | |

As is apparent from the results shown in Table 2, in the case of Examples 1 to 5 where titanium oxide particles having an average primary particle size within a range from 10 to 100 nm and a specific volume resistivity value within a range from 1×10¹ to 1×10⁷ Ω·cm are externally added, both the initial image and the durable image had high image density and also fog and image deletion did not occur, and were therefore good, as compared with the case where titanium oxide particles having an average primary particle size of 7 nm of Comparative Example ¹, titanium oxide particles having an average primary particle size of 150 nm of Comparative Example 2, titanium oxide particles having a specific volume resistivity value of 2×10⁰ Ω·cm of Comparative Example 3 and titanium oxide particles having a specific volume resistivity value of 7×10⁹ Ω·cm of Comparative Example 4 are externally added. Furthermore, in the case where titanium oxide particles having an average primary particle size of 50 nm or more of Examples 2 to 5 are externally added, the image density was high as compared with the case where titanium oxide particles having an average primary particle size of 20 nm of Example 1 are externally added.

### Example B

Examples of a toner for development of an electrostatic latent image used in a touchdown developing type image forming apparatus as shown in FIG. 7 equipped with an amorphous silicon photoconductor will now be described.

Example B is the same as Example A, except that the titanium oxide particles shown in Table 3 are used as the external additive in place of the titanium oxide particles shown in Table 1.

TABLE 3

| | Primary | Specific volume |
|---|---|---|
| | particle | resistivity value |
| | size (nm) | (Ω · cm) |
| Example 6 | 20 | 5 × 10³ |
| Example 7 | 50 | 9 × 10³ |
| Example 8 | 90 | 3 × 10³ |
| Example 9 | 50 | 3 × 10² |
| Example 10 | 50 | 7 × 10⁶ |
| Comparative Example 5 | 7 | 4 × 10³ |
| Comparative Example 6 | 150 | 5 × 10³ |
| Comparative Example 7 | 50 | 2 × 10⁰ |
| Comparative Example 8 | 50 | 7 × 10⁹ |

Evaluation of the image is the same as that in Example A, except that a touchdown developing type image forming apparatus equipped with an amorphous silicon photoconductor (modified by replacing the photoconductor drum of a color page printer “FS-C5016N” manufactured by KYOCERA MITA Corporation by an amorphous silicon photoconductor drum) was used in place of the two-component developing type image forming apparatus equipped with an amorphous silicon photoconductor. The evaluation results are shown in Table 4.

TABLE 4

| Image characteristics | |
|---|---|
| Image density | Fog |

| | | After | | After | Image |
|---|---|---|---|---|---|
| | Initial | printing | Initial | printing | deletion |
| Example 6 | 1.37 | 1.36 | A | A | A |
| Example 7 | 1.41 | 1.39 | A | A | A |
| Example 8 | 1.39 | 1.38 | A | A | A |
| Example 9 | 1.39 | 1.37 | A | A | A |
| Example 10 | 1.40 | 1.38 | A | A | A |
| Comparative | 1.36 | 1.25 | A | C | C |
| Example 5 | | | | | |
| Comparative | 1.29 | 1.14 | B | C | A |
| Example 6 | | | | | |
| Comparative | 1.27 | 1.07 | B | C | A |
| Example 7 | | | | | |
| Comparative | 1.38 | 1.11 | A | C | A |
| Example 8 | | | | | |

As is apparent from the results shown in Table 4, in the case of Examples 6 to 10 where titanium oxide particles having an average primary particle size within a range from 10 to 100 nm and a specific volume resistivity value within a range from 1×10¹ to 1×10⁷ Ω·cm are externally added, both the initial image and the durable image had high image density and also fog and image deletion did not occur, and were therefore good, as compared with the case where titanium oxide particles having an average primary particle size of 7 nm of Comparative Example 5, titanium oxide particles having an average primary particle size of 150 nm of Comparative Example 6, titanium oxide particles having a specific volume resistivity value of 2×10⁰ Ω·cm of Comparative Example 7 and titanium oxide particles having a specific volume resistivity value of 7×10⁹ Ω·cm of Comparative Example 8 are externally added.

### Second Embodiment

The toner for development of an electrostatic latent image according to a second embodiment of the present invention will now be described. The toner for development of an electrostatic latent image according to the present embodiment is a toner used in an image forming apparatus equipped with an organic photoconductor (OPC) and is obtained by externally adding titanium oxide particles to cylindrical toner particles. The titanium oxide particles have an average primary particle size within a range from 10 to 100 nm, and the titanium oxide particles have a specific volume resistivity value within a range from 1×10⁴ to 1×10¹⁵ Ω·cm. Namely the toner for development of an electrostatic latent image according to the second embodiment is the same as the toner for development of an electrostatic latent image according to the first embodiment, except for the titanium oxide particles which are externally added to the cylindrical toner particles. Therefore, the cylindrical toner particles and the magnetic carrier are the same as those in the first embodiment.

### (External Additive)

In the toner for development of an electrostatic latent image according to the present embodiment, the titanium oxide particles as an external additive are added to the cylindrical toner particles. The titanium oxide particles are preferred because they have a function capable of adjusting charging properties of the toner as compared with other external additives such as silica and are excellent in abrasive-performance to the surface of the photoconductor.

The titanium oxide particles are so-called titanium oxide ultrafine particles having an average primary particle size of 10 to 100 nm. When the average primary particle size is less than 10 nm, particles are embedded in the toner from the toner surface during long-term use because they have too small particle size, and thus it is impossible to exert the effect of charge stability of the titanium oxide particles. In contrast, when the average primary particle size is more than 100 nm, a charge amount of the toner decreases to cause image defects such as decrease in image density. Also, the average primary particle size of the titanium oxide particles is preferably 50 nm or more in view of an increase in image density. The average primary particle size can be expressed by an arithmetic mean value calculated from about 100 measured values of the diameter selected optionally from an image at 200,000 times magnification taken under a transmission electron microscope (TEM) of titanium oxide particles.

The specific volume resistivity value of the titanium oxide particles is within a range from 1×10⁴ to 1×10¹⁵ Ω·cm, preferably from 1×10⁵ to 1×10¹⁴ Ω·cm, and more preferably from 1×10⁶ to 1×10¹³ Ω·cm. When the specific volume resistivity value is too low, it becomes impossible to impart sufficient charging properties to the toner and the image density may decrease. In contrast, when the specific volume resistivity value is too high, the charge amount excessively increases and charge-up arises, and thus image density may decrease and durability may deteriorate.

The specific volume resistivity value of the titanium oxide particles varies depending on the image forming apparatus using the toner for development of an electrostatic latent image. When used in an image forming apparatus equipped with an organic photoconductor (OPC), like the toner for development of an electrostatic latent image according to the present embodiment, the specific volume resistivity value of the titanium oxide particles is preferably higher than that when used in an image forming apparatus equipped with an amorphous silicon photoconductor. The reason is considered as follows. Namely, since the organic photoconductor (OPC) has higher with standing voltage as compared with the amorphous silicon photoconductor, microdefects are less likely to be formed on the photoconductor film by leaking micro discharge caused by accumulating a high-resistance toner at the cleaning portion. Namely, in the toner for development of an electrostatic latent image according to the present embodiment, it is scarcely required to consider prevention of formation of microdefects of the photoconductor film, unlike the toner for an amorphous silicon photoconductor, and thus it is not required to use titanium oxide particles having a low specific volume resistivity value. Therefore, in the case of the toner for development of an electrostatic latent image according to the present embodiment, charging properties of the toner are enhanced by using titanium oxide particles having a high specific volume resistivity value, and thus a more stable image can be formed.

The specific volume resistivity value of the titanium oxide particles can be determined by the following procedure. Namely, titanium oxide is placed in a measuring cylindrical cell having a diameter of 25 mm and a load of 1 kg is applied under the conditions of a temperature of 23° C. and a relative humidity of 50°, and then the specific volume resistivity value is determined at an applied voltage of DC 10 V using an ULTRA HIGH RESISTANCE METER R8340A manufactured by ADVANTEST Corporation.

On the surface of the titanium oxide particles, preferably, a tin oxide film containing antimony in the form of a solid solution is formed by adding tin oxide and antimony to the surface, and a specific volume resistivity value of the titanium oxide particles adjusted by the additive amount. The additive amount also varies depending on the particle size of the titanium oxide particles, but is preferably 60 parts by mass or less based on 100 parts by mass of titanium oxide particles. It is sometimes preferred not to add tin oxide and antimony to the titanium oxide particles used in the present embodiment. It is also preferred to hydrophobize the titanium oxide particles by further adding 5 to 10 parts by mass of a coupling agent, for example, a titanate coupling agent.

The image forming apparatus using the toner for development of an electrostatic latent image according to the present embodiment is the same as the image forming apparatus used in the first embodiment, except that an amorphous photoconductor is used in place of an organic photoconductor (OPC).

### EXAMPLES

The toner for development of an electrostatic latent image of the second embodiment will now be described in more detail by way of Examples. However, the present invention is no limited to Examples.

### Example C

Examples of a toner for development of an electrostatic latent image used in a two-component developing type image forming apparatus as shown in FIG. 6 equipped with an organic photoconductor (OPC) will now be described.

Example C is the same as Example A, except that the titanium oxide particles shown in Table 5 are used as the external additive in place of the titanium oxide particles shown in Table 1.

TABLE 5

| | Primary | Specific volume |
|---|---|---|
| | particle size | resistivity value |
| | (nm) | (Ω · cm) |
| Example 11 | 20 | 4 × 10⁸ |
| Example 12 | 50 | 8 × 10⁸ |
| Example 13 | 90 | 7 × 10⁸ |
| Example 14 | 50 | 9 × 10⁵ |
| Example 15 | 50 | 7 × 10¹³ |
| Comparative Example 9 | 7 | 2 × 10⁸ |
| Comparative Example 10 | 150 | 3 × 10⁸ |
| Comparative Example 11 | 50 | 2 × 10³ |
| Comparative Example 12 | 50 | 4 × 10¹⁶ |

Evaluation of the image is the same as that in Example A, except that a two-component developing type image forming apparatus equipped with an organic photoconductor (OPC) (which is obtained by modifying a page printer “FS-1030D” manufactured by KYOCERA MITA Corporation so as to employ a two-component developing method as the developing method) was used in place of the two-component developing type image forming apparatus equipped with an amorphous silicon photoconductor. The evaluation results are shown in Table 6.

TABLE 6

| Image characteristics | |
|---|---|
| Image density | Fog |

| | | After | | After | Image |
|---|---|---|---|---|---|
| | Initial | printing | Initial | printing | deletion |
| Example 11 | 1.38 | 1.37 | A | A | A |
| Example 12 | 1.41 | 1.39 | A | A | A |
| Example 13 | 1.42 | 1.41 | A | A | A |
| Example 14 | 1.37 | 1.35 | A | A | A |
| Example 15 | 1.40 | 1.36 | A | A | A |
| Comparative | 1.39 | 1.25 | A | C | C |
| Example 9 | | | | | |
| Comparative | 1.25 | 1.09 | B | C | A |
| Example 10 | | | | | |
| Comparative | 1.23 | 1.02 | B | C | A |
| Example 11 | | | | | |
| Comparative | 1.38 | 1.05 | A | C | A |
| Example 12 | | | | | |

As is apparent from the results shown in Table 6, in the case of Examples 11 to 15 where titanium oxide particles having an average primary particle size within a range from 10 to 100 nm and a specific volume resistivity value within a range from 1×10⁴ to 1×10¹⁵ Ω·cm are externally added, both the initial image and the durable image had high image density and also fog and image deletion did not occur, and were therefore good, as compared with the case where titanium oxide particles having an average primary particle size of 7 nm of Comparative Example 9, titanium oxide particles having an average primary particle size of 150 nm of Comparative Example 10, titanium oxide particles having a specific volume resistivity value of 2×10³ Ω·cm of Comparative Example 11 and titanium oxide particles having a specific volume resistivity value of 4×10¹⁶ Ω·cm of Comparative Example 12 are externally added.

### Example D

Examples of a toner for development of an electrostatic latent image used in a touchdown developing type image forming apparatus as shown in FIG. 7 equipped with an organic photoconductor (OPC) will now be described.

Example D is the same as Example A, except that the titanium oxide particles shown in Table 7 are used as the external additive in place of the titanium oxide particles shown in Table 5.

TABLE 7

| | Primary | Specific volume |
|---|---|---|
| | particle size | resistivity value |
| | (nm) | (Ω · cm) |
| Example 16 | 20 | 3 × 10⁸ |
| Example 17 | 50 | 9 × 10⁸ |
| Example 18 | 90 | 7 × 10⁸ |
| Example 19 | 50 | 2 × 10⁵ |
| Example 20 | 50 | 8 × 10¹³ |
| Comparative Example 13 | 7 | 5 × 10⁸ |
| Comparative Example 14 | 150 | 1 × 10⁸ |
| Comparative Example 15 | 50 | 3 × 10³ |
| Comparative Example 16 | 50 | 9 × 10¹⁶ |

Evaluation of the image is the same as that in Example A, except that a touchdown developing type image forming apparatus equipped with an organic photoconductor (OPC) (color page printer “FS-C5016N” manufactured by KYOCERA MITA Corporation) was used in place of the two-component developing type image forming apparatus equipped with an amorphous silicon photoconductor. The evaluation results are shown in Table 8.

TABLE 8

| Image characteristics | |
|---|---|
| Image density | Fog |

| | | After | | After | Image |
|---|---|---|---|---|---|
| | Initial | printing | Initial | printing | deletion |
| Example 16 | 1.39 | 1.37 | A | A | A |
| Example 17 | 1.40 | 1.41 | A | A | A |
| Example 18 | 1.42 | 1.40 | A | A | A |
| Example 19 | 1.38 | 1.36 | A | A | A |
| Example 20 | 1.41 | 1.38 | A | A | A |
| Comparative | 1.37 | 1.27 | A | C | C |
| Example 13 | | | | | |
| Comparative | 1.27 | 1.11 | B | C | A |
| Example 14 | | | | | |
| Comparative | 1.25 | 1.05 | B | C | A |
| Example 15 | | | | | |
| Comparative | 1.39 | 1.09 | A | C | A |
| Example 16 | | | | | |

As is apparent from the results shown in Table 8, in the case of Examples 16 to 20 where titanium oxide particles having an average primary particle size within a range from 10 to 100 nm and a specific volume resistivity value within a range from 1×10⁴ to 1×10¹⁵ Ω·cm are externally added, both the initial image and the durable image had high image density and also fog and image deletion did not occur, and were therefore good, as compared with the case where titanium oxide particles having an average primary particle size of 7 nm of Comparative Example 13, titanium oxide particles having an average primary particle size of 150 nm of Comparative Example 14, titanium oxide particles having a specific volume resistivity value of 3×10³ Ω·cm of Comparative Example 15 and titanium oxide particles having a specific volume resistivity value of 9×10¹⁶ Ω·cm of Comparative Example 16 are externally added.

One aspect described in detail above of the present invention pertains to a toner for development of an electrostatic latent image, which is used in an image forming apparatus equipped with an amorphous silicon photoconductor, comprising cylindrical toner particles and titanium oxide particles added externally to the cylindrical toner particles, wherein the titanium oxide particles have an average primary particle size within a range from 10 to 100 nm, and the titanium oxide particles have a specific volume resistivity value within a range from 1×10¹ to 1×10⁷ Ω·cm. The cylindrical toner particles have an edge, unlike conventional toner particles, and therefore the cylindrical toner particles can properly scratch the surface of a photoconductor. Since the cylindrical toner particles can exert an scratching effect, the toner does not adhere onto the surface of the photoconductor and also image defects such as image deletion do not occur even if titanium oxide particles having a comparatively large average primary particle size are not externally added. Therefore, it is possible to use, as an external additive, the titanium oxide particles having an average primary particle size within a range from 10 to 100 nm which is preferred in view of charge characteristics. As a result, when such a toner for development of an electrostatic latent image is used in an image forming apparatus equipped with an amorphous silicon photoconductor, it is possible to suppress an image deletion phenomenon and to improve charge characteristics, and thus exerts an extremely excellent effect on long-term printing durability.

Also, the cylindrical toner particles are preferably obtained by cutting a fiber formed of a toner material cylindrical toner particles in view of uniformization of the particle size (cylindrical length and cylindrical diameter) of the cylindrical toner particles.

Also, it is preferred that the titanium oxide particles contain tin oxide and antimony added to the surface thereof, and the specific volume resistivity value is adjusted by adjusting the amount of the tin oxide and antimony to be added in view of ease of adjustment of the volume resistance value of the titanium oxide particles.

Also, the titanium oxide particles preferably have a primary particle size within a range from 50 to 100 nm in view of an increase in image density.

Also, another aspect of the present invention pertains to an image forming apparatus comprising an image carrier on which an electrostatic latent image is formed, and a developing roller which is disposed in a state of facing the image carrier and conveys a two-component developer containing a toner and a carrier while supporting the two-component developer on the surface of the developing roller, wherein the two-component developer conveyed by the developing roller is supplied on the surface of the image carrier, thereby visualizing the electrostatic latent image formed preliminarily on the surface of the image carrier as a toner image, and the toner image is transferred onto a recording medium to form an image, and wherein the toner for development of an electrostatic latent image is used as the toner.

Also, another aspect of the present invention pertains to an image forming apparatus comprising an image carrier on which an electrostatic latent image is formed, a developing roller which is disposed in a state of facing the image carrier and conveys a toner while supporting the toner on the surface of the developing roller, and a magnetic roller which supports a two-component developer containing a toner and a carrier and conveys the two-component developer, wherein the toner in the two-component developer conveyed by the magnetic roller is migrated to the surface of the developing roller and the toner conveyed by the developing roller is supplied on the surface of the image carrier, thereby visualizing the electrostatic latent image formed preliminarily on the surface of the image carrier as a toner image, and the toner image is transferred onto a recording medium to form an image, and wherein the toner for development of an electrostatic latent image is used as the toner.

Another aspect of the present invention pertains to a toner for development of an electrostatic latent image, which is used in an image forming apparatus equipped with an organic photoconductor (OPC), comprising cylindrical toner particles and titanium oxide particles added externally to the cylindrical toner particles, wherein the titanium oxide particles have an average primary particle size within a range from 10 to 100 nm, and the titanium oxide particles have a specific volume resistivity value within a range from 1×10⁴ to 1×10¹⁵ Ω·cm. The cylindrical toner particles have an edge, unlike conventional toner particles, and therefore the cylindrical toner particles can properly scratch the surface of a photoconductor. Since the cylindrical toner particles can exert an scratching effect, the toner does not adhere onto the surface of the photoconductor and also image defects such as image deletion do not occur even if titanium oxide particles having a comparatively large average primary particle size are not externally added. Therefore, it is possible to use, as an external additive, the titanium oxide particles having an average primary particle size within a range from 10 to 100 nm which is preferred in view of charge characteristics. As a result, when such a toner for development of an electrostatic latent image is used in an image forming apparatus equipped with an organic photoconductor (OPC), it is possible to suppress an image deletion phenomenon and to improve charge characteristics, and thus exerts an extremely excellent effect on long-term printing durability.

Also, the cylindrical toner particles are preferably obtained by cutting a fiber formed of a toner material in view of uniformization of the particle size (cylindrical length and cylindrical diameter) of the cylindrical toner particles.

Also, it is preferred that the titanium oxide particles contain tin oxide and antimony added to the surface thereof, and the specific volume resistivity value is adjusted by adjusting the amount of the tin oxide and antimony to be added in view of ease of adjustment of the volume resistance value of the titanium oxide particles.

Also, the titanium oxide particles preferably have a primary particle size within a range from 50 to 100 nm in view of an increase in image density.

Also, another aspect of the present invention pertains to an image forming apparatus comprising an image carrier on which an electrostatic latent image is formed, and a developing roller which is disposed in a state of facing the image carrier and conveys a two-component developer containing a toner and a carrier while supporting the two-component developer on a surface of the developing roller, wherein the two-component developer conveyed by the developing roller is supplied on a surface of the image carrier, thereby visualizing the electrostatic latent image formed preliminarily on the surface of the image carrier as a toner image, and the toner image is transferred onto a recording medium to form an image, and wherein the toner for development of an electrostatic latent image is used as the toner.

Also, another aspect of the present invention pertains to an image forming apparatus comprising an image carrier on which an electrostatic latent image is formed, a developing roller which is disposed in a state of facing the image carrier and conveys a toner while supporting the toner on the surface of the developing roller, and a magnetic roller which supports a two-component developer containing a toner and a carrier and conveys the two-component developer, wherein the toner in the two-component developer conveyed by the magnetic roller is migrated to the surface of the developing roller and the toner conveyed by the developing roller is supplied on the surface of the image carrier, thereby visualizing the electrostatic latent image formed preliminarily on the surface of the image carrier as a toner image, and the toner image is transferred onto a recording medium to form an image, and wherein the toner for development of an electrostatic latent image is used as the toner.

This application is based on Japanese Patent application serial nos. 2006-321712, 2006-321713, 2006-321714, and 2007-123713 filed in Japan, the contents of which are hereby incorporated by reference.

Although the present invention has been fully described by way of example, it is to be understood that various changes and modifications will be apparent to those skilled in the art. Therefore, unless otherwise such changes and modifications depart from the scope of the present invention hereinafter defined, they should be construed as being included therein.

What is claimed is:

1. A toner for development of an electrostatic latent image, which is used in an image forming apparatus equipped with an amorphous silicon photoconductor, comprising:
cylindrical toner particles and titanium oxide particles added externally to the cylindrical toner particles, wherein
the titanium oxide particles have an average primary particle size within a range from 10 to 100 nm, and
the titanium oxide particles have a specific volume resistivity value within a range from 1×10¹ to 1×10⁷ Ω·cm.

2. The toner for development of an electrostatic latent image according to claim 1, wherein the cylindrical toner particles are obtained by cutting a fiber formed of a toner material.

3. The toner for development of an electrostatic latent image according to claim 1, wherein the titanium oxide particles contain tin oxide and antimony added to the surface thereof, and
a specific volume resistivity value is adjusted by adjusting an amount of the tin oxide and the antimony to be added.

4. The toner for development of an electrostatic latent image according to claim 1, wherein the titanium oxide particles have a primary particle size within a range from 50 to 100 nm.

5. An image forming apparatus comprising:
an image carrier on which an electrostatic latent image is formed, and a developing roller which is disposed in a state of facing the image carrier and conveys a two-component developer containing a toner and a carrier while supporting the two-component developer on a surface of the developing roller, wherein
the two-component developer conveyed by the developing roller is supplied on a surface of the image carrier, thereby visualizing the electrostatic latent image formed preliminarily on the surface of the image carrier as a toner image, and the toner image is transferred onto a recording medium to form an image, and wherein
the toner for development of an electrostatic latent image according to claim 1 is used as the toner.

6. An image forming apparatus comprising:
an image carrier on which an electrostatic latent image is formed, a developing roller which is disposed in a state of facing the image carrier and conveys a toner while supporting the toner on a surface of the developing roller, and a magnetic roller which supports a two-component developer containing a toner and a carrier and conveys the two-component developer, wherein
the toner in the two-component developer conveyed by the magnetic roller is migrated to the surface of the developing roller and the toner conveyed by the developing roller is supplied on a surface of the image carrier, thereby visualizing the electrostatic latent image formed preliminarily on the surface of the image carrier as a toner image, and the toner image is transferred onto a recording medium to form an image, and wherein
the toner for development of an electrostatic latent image according to claim 1 is used as the toner.

7. A toner for development of an electrostatic latent image, which is used in an image forming apparatus equipped with an organic photoconductor (OPC), comprising:
cylindrical toner particles and titanium oxide particles added externally to the cylindrical toner particles, wherein
the titanium oxide particles have an average primary particle size within a range from 10 to 100 nm, and
the titanium oxide particles have a specific volume resistivity value within a range from 1×10⁴ to 1×10¹⁵ Ω·cm.

8. The toner for development of an electrostatic latent image according to claim 7, wherein the cylindrical toner particles are obtained by cutting a fiber formed of the toner material.

9. The toner for development of an electrostatic latent image according to claim 7, wherein the titanium oxide particles contain tin oxide and antimony added to the surface, and
a specific volume resistivity value is adjusted by adjusting an amount of the tin oxide and the antimony to be added.

10. The toner for development of an electrostatic latent image according to claim 7, wherein the titanium oxide particles have a primary particle size within a range from 50 to 100 nm.

11. An image forming apparatus comprising:
an image carrier on which an electrostatic latent image is formed, and a developing roller which is disposed in a state of facing the image carrier and conveys a two-component developer containing a toner and a carrier while supporting the two-component developer on a surface of the developing roller, wherein
the two-component developer conveyed by the developing roller is supplied on a surface of the image carrier, thereby visualizing the electrostatic latent image formed preliminarily on the surface of the image carrier as a toner image, and the toner image is transferred onto a recording medium to form an image, and wherein
the toner for development of an electrostatic latent image according to claim 7 is used as the toner.

12. An image forming apparatus comprising:
an image carrier on which an electrostatic latent image is formed, a developing roller which is disposed in a state of facing the image carrier and conveys a toner while supporting the toner on the surface of the developing roller, and a magnetic roller which supports a two-component developer containing a toner and a carrier and conveys the two-component developer, wherein
the toner in the two-component developer conveyed by the magnetic roller is migrated to the surface of the developing roller and the toner conveyed by the developing roller is supplied on a surface of the image carrier, thereby visualizing the electrostatic latent image formed preliminarily on the surface of the image carrier as a toner image, and the toner image is transferred onto a recording medium to form an image, and wherein
the toner for development of an electrostatic latent image according to claim 7 is used as the toner.
